(19) United States
(12) Patent Application Publication
(10) Pub. No.: US 2011/0001623 A1
(43) Pub. Date: Jan. 6, 2011

(54) DOZING WARNING SYSTEM AND GLASSES EQUIPPED WITH THE SAME

(76) Inventor: Yong-un Kim, Seoul (KR)

Correspondence Address: EDWARDS ANGELL PALMER & DODGE LLP, P.O. BOX 55874, BOSTON, MA, 02205, US

(21) Appl. No.: 12/620,240

(22) Filed: Nov. 17, 2009

(30) Foreign Application Priority Data
Jul. 1, 2009 (KR) KR10-2009-0062887

(51) Int. Cl. G08B 23/00

(52) U.S. Cl. 340/575

(57) ABSTRACT

Disclosed herein is a dozing warning system. The dosing warning system includes an angle sensor unit, a control unit, and a warning unit. The angle sensor unit detects the angle of inclination of a user's head in a state level with a reference surface. The control unit compares the angle of inclination, detected by the angle sensor unit, with a previously stored reference angle. The warning unit outputs a warning signal if the control unit determines that the detected angle of inclination exceeds the reference angle. The control unit may output a warning signal only if the detected angle of inclination is maintained for a period equal to or longer than a reference period if the detected angle of inclination exceeds the reference angle.

### CROSS-REFERENCE TO RELATED APPLICATION

This application claims under 35 U.S.C. §119(a) the benefit of Korean Application No. 10-2009-0062887 filed Jul. 1, 2009, the entire contents of which are incorporated herein by reference.

### BACKGROUND

1. Technical Field

The present invention relates generally to dozing warning glasses, and, more particularly, to glasses that detect a user's nodding his or her head when he or she dozes off and then provide vibrations or a sound warning, thereby warning the user of the dozing state.

2. Related Art

In general, there are many cases where persons doze off and nod their heads when they are driving a vehicle, are at their studies or are performing their work. There is concern that dozing while driving may cause a traffic accident, dozing while studying deteriorates the effects of studying and dozing while working reduces work efficiency.

In order to overcome dozing in such conditions, a method of drinking beverages containing stimulants, such as coffee, and a method using chewing gum have been conventionally used. However, it is difficult to drink coffee while driving and drinking coffee may cause an accident, and the action of peeling the packing of gum to chew chewing gum may cause an accident.

Furthermore, drinking beverages containing stimulants, such as coffee, affects individuals differently, so that it may be difficult for some individuals to prevent dozing by drinking such beverages. Drinking coffee to overcome dozing is problematic in that people usually leave their seats to get the coffee, so that work efficiency may be reduced.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

Accordingly, the present invention has been made keeping in mind the above problems occurring in the prior art, and an object of the present invention is to provide dozing warning glasses which are capable of warning a user of a dozing state when he or she dozes off while driving a vehicle or performing work, thereby preventing traffic accidents and improving work efficiency.

In order to accomplish the above object, the present invention provides a dozing warning system, including an angle sensor unit for detecting the angle of inclination of a user's head in a state level with a reference surface; a control unit for comparing the angle of inclination, detected by the angle sensor unit, with a previously stored reference angle; and a warning unit for outputting a warning signal if the control unit determines that the detected angle of inclination exceeds the reference angle.

As a result, when a user dozes off while driving, studying or working, the dozing is detected and then the user is warned of the dozing state, so that the user is brought to attention, thereby preventing traffic accidents or improving study or work efficiency.

Furthermore, a memory unit for storing data about reference angles is further included, the reference angles are set for respective steps, and the control unit amplifies the output signal from the warning unit depending on the respective steps in line with the reference angles for the respective steps.

As a result, the angles of inclination of the head are detected based on steps and then an output signal is amplified accordingly, so the warning of being in a dozing state can be conducted efficiently. That is, when the angle of inclination of the head is great, this means that the dozing is deep, so that warning output is amplified so that the user can sense the warning.

Furthermore, it is preferred that the warning unit output vibrations or a warning sound.

As a result, vibrations and a warning sound are selectively output according to the user's preferences, so that the dozing warning system can be set to vibration mode in a place such as a library, thereby minimizing disturbing adjacent people.

Meanwhile, it is preferred that the dozing warning system be installed on glasses.

As a result, when the dozing warning system is installed on glasses in line with increase in the number of persons wearing glasses, the dozing warning system can be conveniently used without using a separate device or terminal.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing glasses equipped with a dozing warning system according to a preferred embodiment of the present invention;

FIG. 2 is a block diagram showing a dozing warning system according to the preferred embodiment of the present invention;

FIG. 3 is a flowchart illustrating the operation of the dozing warning system of FIG. 2; and

FIGS. 4A and 4B are flowcharts illustrating another operation of the dozing warning system of FIG. 2 according to another embodiment of the present invention.

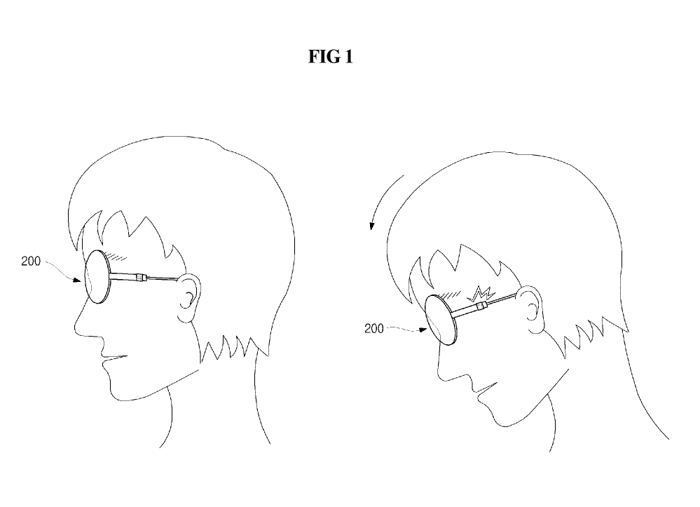

### DETAILED DESCRIPTION OF THE DISCLOSURE

Reference now should be made to the drawings, in which the same reference numerals are used throughout the different drawings to designate the same or similar components.

Dozing warning glasses according to a preferred embodiment of the present invention will be described in detail below with reference to the accompanying drawings.

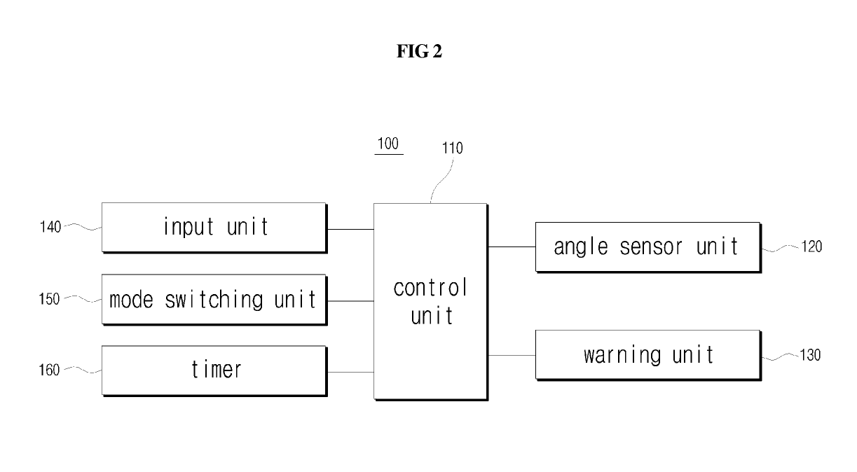

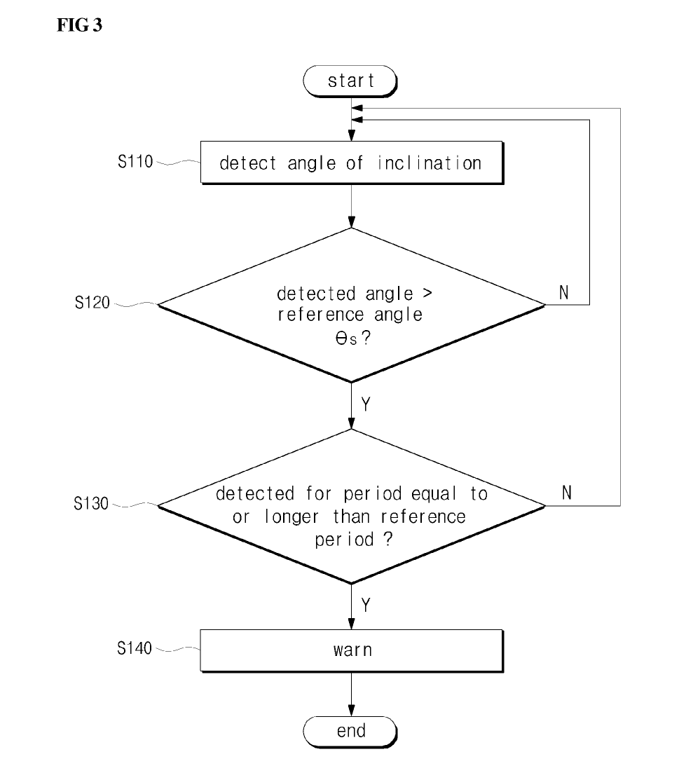

FIG. 2 is a block diagram showing a dozing warning system according to a preferred embodiment of the present invention, and FIG. 3 is a diagram showing glasses equipped with the dozing warning system of FIG. 2.

Referring to FIG. 2, a dozing warning system 100 according to a preferred embodiment of the present invention includes an angle sensor unit 120, a control unit 110, and a warning unit 130.

The angle sensor unit 120 detects the angle of inclination of a user's head. The angle sensor unit 120 is located near the user's head, and detects the angle of forward and backward inclination of the user's head when he or she dozes off. It is preferred that the angle sensor unit 120 be attached to a hair band, a hair pin or glasses and then applied to the dozing warning system without requiring a separate device or terminal. Here, the angle sensor unit 120 measures the angle of inclination with respect to a reference surface, that is, a horizontal state, and may measure angles using any of an angle measurement method using an encoder, an angle measurement method using an accelerator sensor and an angle measurement method using a gyro sensor.

The control unit 110 receives a signal related to the angle of inclination detected by the angle sensor unit 120, and controls the warning unit 130. In order to treat the typical inclination of the head as noise, it is preferred that the warning unit 130 output a warning signal only if a detected angle exceeds a predetermined angle.

Accordingly, the control unit 110 determines whether the received angle of inclination θₛ exceeds a preset reference angle, and operates the warning unit 130 only if the received angle exceeds that reference angle, thereby preventing a warning signal from being generated when the received angle of inclination does not exceed the reference value.

Meanwhile, according to a preferred embodiment of the present invention, a timer 160 is further included, so that the control unit 110 enables a warning signal to be output only if the angle of inclination θₛ detected by the angle sensor unit 120 is maintained within an error range for a period equal to or longer than a reference period, thereby preventing the problem of a warning signal being indiscriminately output when the user is just drooping his or her head to perform some work or satisfy some other desire. That is, in order to prevent a warning from being output when the user droops his or her head to pick up an object off of a support surface or satisfy some other desire, it is preferred that the control unit 110 receive the angle of inclination θₛ detected by the angle sensor unit 120 and allow a warning signal to be output only when the received angle of inclination θₛ has been detected for a period equal to or longer than the reference period.

The warning unit 130 outputs vibrations or a warning sound when the control unit 110 determines that the user is currently dozing off. It is preferred that the warning unit 130 further include a mode switching unit 150 so that the warning unit 130 can switch between a vibration or warning sound output mode according to the user's preferences. As a result, the system of the present invention can be used to prevent dozing in quiet places, such as a library, without disturbing adjacent people.

Meanwhile, according to a preferred embodiment of the present invention, an input unit 140 is further included so as to adjust a reference inclination value depending on the user's working type or working posture. Since a person may bend his or her head during study or users bend their heads at different angles so as to conduct various actions, it is preferable to adjust the reference inclination value, thereby enabling a dozing warning suitable for the posture of a specific user to be output.

Furthermore, according to a preferred embodiment of the present invention, reference angles are provided for respective steps, so that the warning signal output by the warning unit 130 can be amplified depending on the steps. Accordingly, since the increase in the angle of inclination of the head may indicate the increase in the severity of dozing, a warning signal suitable for the user's current situation can be output in such a way that a weak signal is output when the head is slightly inclined and a strong signal is output when the head is severely inclined, thereby enabling effective dozing prevention.

That is, if only an output signal of constant magnitude is output regardless of the current state of the user's dozing, the user may not detect the warning signal when he or she is dozing deeply. Meanwhile, when the user is dozing slightly, a strong output warning signal may startle the user, with the result that the warning signal may cause an accident when given during driving. Accordingly, the magnitude of the output of the warning signal may be adjusted by the input unit 140.

Furthermore, the reference angle or the reference angles for respective steps may be previously stored in a memory unit (not shown). It is preferred that such a reference angle is input and stored in the memory unit by the user's input, so that the user can immediately use the reference angle without requiring a separate setting whenever he or she uses it.

Meanwhile, according to a preferred embodiment of the present invention, the dozing warning system 100 may be attached to glasses 200 and the user can enjoy the effect of the dozing warning system 100 by wearing the glasses 200. Although only the glasses have been described and illustrated hitherto, the dozing warning system 100 may be applied to a hair band and a hair pin, in addition to the glasses 200.

The operation of the dozing warning system according to a preferred embodiment of the present invention will be described with reference to FIG. 3.

When the angle of inclination of the user's head is detected by the angle sensor unit 120 at step S110, the control unit 110 determines whether the detected angle of inclination exceeds a reference angle by comparing the detected angle of inclination θₛ with the reference angle previously stored or input by the user at step S120. If the detected angle of inclination exceeds the reference angle, whether the detected angle of inclination has exceeded the reference angle within a predetermined error range is determined at step S130. If the detected angle of inclination has exceeded the reference angle for a period equal to or longer than a reference period, the user is determined to have dozed off and then vibrations or a warning sound are output, thereby warning the user of dozing at step S140.

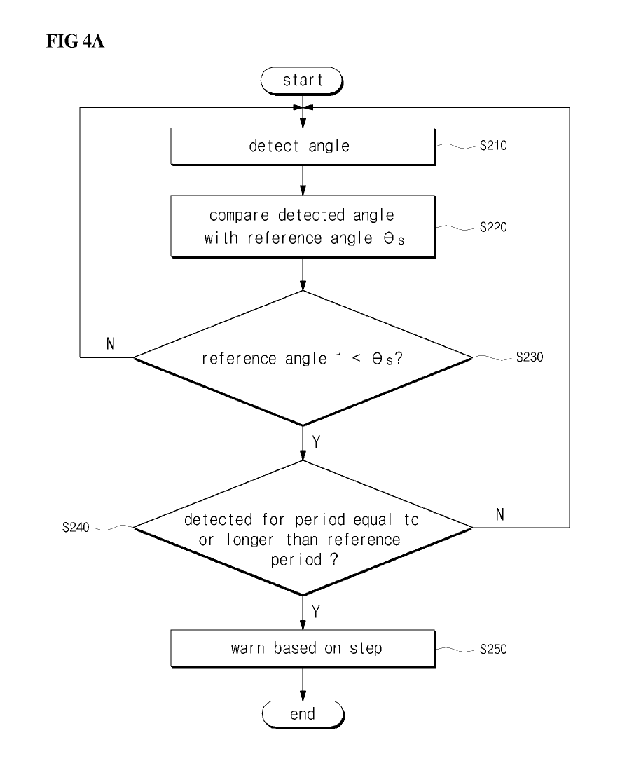

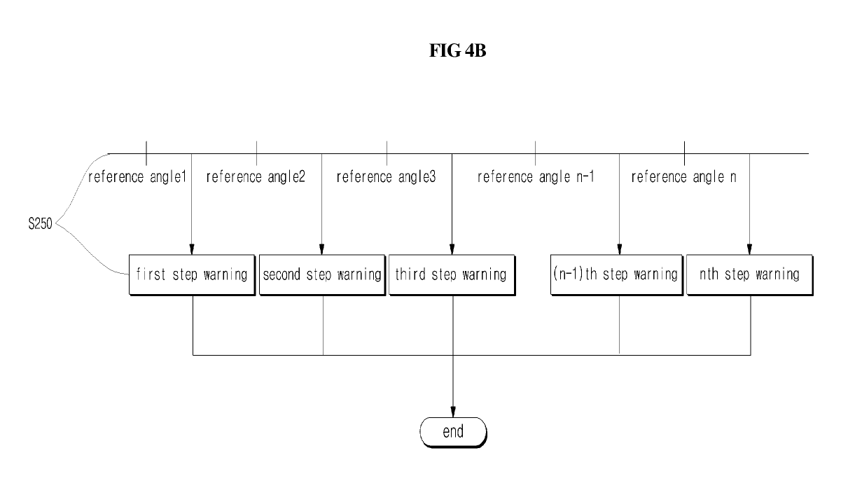

Meanwhile, it is preferable to provide reference angles for respective steps and amplify an output warning signal depending on the angle of inclination θₛ of the user's head. This will be described in detail below with reference to FIGS. 4A and 4B.

The angle of inclination of the user's head is detected at step S210. The detected angle of inclination θₛ is compared with the reference angle S220. If the detected angle of inclination θₛ is less than reference angle 1 at step S230, the angle of inclination of the user's head is continuously monitored at step S210. If the angle of inclination θₛ is greater than reference angle 1 and less than reference angle 2, a first step warning which is weak is issued. If the angle of inclination θₛ is greater than reference angle 2 and less than reference angle 3, a second step warning which is slightly stronger than the first step warning is issued. If the angle of inclination θₛ is greater than reference angle 3 and less than reference angle 4, a third step warning which is stronger than the second step warning is issued. In brief, a plurality of warning steps may be set according to the user's preferences, as shown by step S250 of FIG. 4B.

Meanwhile, before a warning signal for each step is finally output, whether the detected angle of inclination θₛ has been continuously maintained within a predetermined error range for a period equal to or longer than the reference period is determined at step S240. The warning step is performed only if the detected angle of inclination θₛ is determined to have been continuously maintained within a predetermined error range for a period equal to or longer than the reference period.

According to the present invention, when a user dozes off while driving, studying or working, the dozing is detected and then the user is warned of the dozing, so that the user is brought to attention, thereby preventing a traffic accident or improving study or work efficiency.

Furthermore, the angles of inclination of the head are detected based on steps and an output signal is amplified accordingly, so the warning of being in a dozing state can be performed efficiently. That is, when the angle of inclination of the head is great, this means that dozing is deep, so that warning output is amplified so that the user can sense the warning.

Furthermore, vibrations or a warning sound are selectively output according to the user's preferences, so that the dozing warning system may be set to vibration mode in places such as a library, thereby minimizing disturbing adjacent people.

Furthermore, when the dozing warning system is installed on glasses in line with increase in the number of persons wearing glasses, the dozing warning system can be conveniently used without using a separate device or terminal.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A dozing warning system, comprising:
an angle sensor unit for detecting an angle of inclination of a user's head in a state level with a reference surface;
a control unit for comparing the angle of inclination, detected by the angle sensor unit, with a previously stored reference angle; and
a warning unit for outputting a warning signal if the control unit determines that the detected angle of inclination exceeds the reference angle.

2. The dozing warning system as set forth in claim 1, wherein the control unit outputs a warning signal only if the detected angle of inclination is maintained for a period equal to or longer than a reference period if the detected angle of inclination exceeds the reference angle.

3. The dozing warning system as set forth in claim 2, wherein the reference angle comprises multiple reference angles which are set for respective steps.

4. The dozing warning system as set forth in claim 3, wherein the control unit amplifies the output signal from the warning unit depending on the respective steps in line with the reference angles for the respective steps.

5. The dozing warning system as set forth in claim 4, wherein the warning unit outputs vibrations or a warning sound.

6. Glasses equipped with the dozing warning system set forth in any one of claims 1 to 5.
